(19) United States
(12) Patent Application Publication
(10) Pub. No.: US 2016/0241904 A1
(43) Pub. Date: Aug. 18, 2016

(54) Electronic Device, Electronic Device Control Method and Electronic Device Control System

(71) Applicants: Toshiba Lifestyle Products & Services Corporation, Tokyo (JP); KABUSHIKI KAISHA TOSHIBA, Tokyo (JP)

(72) Inventor: Chikara Ushimaru, Akishima Tokyo (JP)

(73) Assignees: KABUSHIKI KAISHA TOSHIBA, Tokyo (JP); Toshiba Lifestyle Products & Services Corporation, Tokyo (JP)

(21) Appl. No.: 14/958,692

(22) Filed: Dec. 3, 2015

Related U.S. Application Data
(60) Provisional application No. 62/115,459, filed on Feb. 12, 2015.

(51) Int. Cl. H04N 21/431; H04N 21/488; H04N 21/422; H04L 29/06

(52) U.S. Cl. CPC H04N 21/4312; H04L 67/42; H04N 21/4888; H04N 21/42204

(57) ABSTRACT

According to one embodiment, a receiver communicates with an external device based on an operation of an operation button, and receives identification information for identifying areas in a display screen and an image associated with the identification information, the areas including a first and a second areas, the image including a first image to be displayed on the first area associated with first identification information. And a request unit makes a request to get a right of use of the second area, and an image generator generates a second image based on a unique operation and arranges it in the second area, after the right of use of the second area is obtained.

### CROSS-REFERENCE TO RELATED APPLICATIONS

This application claims the benefit of U.S. Provisional Application No. 62/115,459, filed Feb. 12, 2015, the entire contents of which are incorporated herein by reference.

### FIELD

Embodiments described herein relate generally to an electronic device, a method of controlling an electronic device, and an electronic device control system.

### BACKGROUND

Client devices and electronic devices such as information recording reproducing devices (also called client devices) comprise a remote controller as an attached component. A number of operation keys (also called operation buttons) are arranged in the remote controller. When the user selects and presses an operation button of the remote controller, the operation result of the operation button is reflected on a client device.

Recent client devices include a number of functions, and methods of operating of such devices are also various. And advanced client devices including new functions are soled onto the market over time. Therefore, the operation buttons are further increased on the remote controller. And the remote controller is provided with operation buttons each used for a plurality of operations.

If operation buttons and operation items of the remote controller increase as advanced new client devices are developed, image display programs for a user interface (UI) need to be updated or changed, and the remote controller needs to be newly designed. Thus, the design cost of a UI system increases, and the price of the client devices becomes high, as a result.

To solve such a problem, a method of storing UI data in a server and providing UI data required by an electronic device from the server to the client device is conceivable. This method allows the client device to request the UI data to the server, and allows UI images (including new operation buttons and operation items) to be displayed based on the UI data transmitted from the server. To operate the client device, the user controls, for example, a cursor on a UI image using the remote controller, selects a desired operation button or item, and presses a determination button. Then, identification data of the selected desired operation button or operation item is indicated from the client device to the server. The server transmits instruction data for controlling the client device in response to the identification data. This avoids the need for providing the client device and/or the remote controller with a number of functions, and allows a lot of functions of the client device to be easily controlled. However, in this method, the server completely dominates and controls the display of the UI images such as operation buttons and operation items of the client device.

If the display of the UI image of the client device is controlled by the server in this manner, and all operations to the client device are limited by the operation buttons or operation items shown in the UI images from the server, flexibility of operations of the client device may be restricted.

Embodiments described herein aim to provide an electronic device, a method of controlling an electronic device, and an electronic device control system which allow a first guide image (first UI image) generated based on communication with an external device and a second guide image (second UI image) generated by the electronic device based on a unique operation to be simultaneously displayed, and enable the user to easily operate the electronic device in various ways.

An electronic device according to one embodiment comprises a receiver configured to communicate with an external device based on an operation of an arbitrary operation button, and to acquire, from the external device, user interface (UI) data including identification information for identifying a plurality of areas constituting a display screen and at least one image associated with the identification information, the plurality of areas including a first area and a second area different from the first area, the at least one image including a first image, and the first image being associated with first identification information indicative of the first area, a request unit configured to make a request for specifying the second area to the external device, and to accept a right of use of the second area from a control area of the external device, and an image generator configured to generate a screen image in which the first image is arranged in the first area based on the UI data and a second image generated based on a unique operation is arranged in the second area, after the right of use of the second area is accepted.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 shows a typical configuration example of an electronic device control system according to one embodiment.

FIG. 2 shows an outer appearance of a remote controller used in one embodiment.

FIG. 3 is an explanatory chart of an operation example of a remote UI system constructed between a client device 100 and server 500 or 600.

FIG. 4 shows a typical example of a UI image displayed in a client device in one embodiment.

FIG. 5 shows another typical example of a UI image displayed in a client device in one embodiment.

FIG. 6 shows a typical configuration example of an electronic device control system according to another embodiment.

FIG. 7 shows a typical example of a table of button information transmitted from a client device to a server in an embodiment.

FIG. 8 shows a typical example in which an operation guide transmitted from a server to a client device is displayed in another embodiment.

FIG. 9 shows yet another typical example in which an operation guide transmitted from a server to a client device is displayed in another embodiment.

FIG. 10 shows yet another typical example in which an operation guide transmitted from a server to a client device is displayed in another embodiment.

FIG. 11 shows a typical configuration example of a client device (television receiver) according to an embodiment.

FIG. 12 shows a typical configuration example of a controller of the client device shown in FIG. 11.

FIG. 13 shows a typical configuration example of a server of each embodiment.

### DETAILED DESCRIPTION

Embodiments will be hereinafter described with reference to the accompanying drawings.

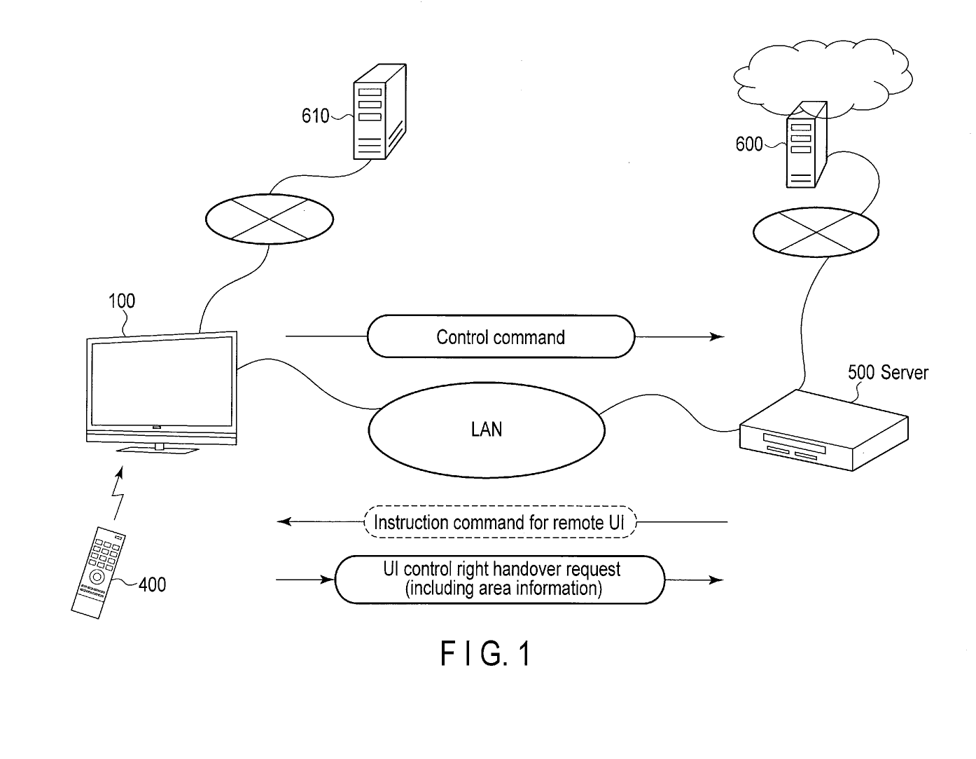

FIG. 1 shows a typical configuration example of an electronic device control system according to one embodiment. Reference number 100 denotes, for example, a television receiver. A television receiver 100 may be called a client device. It will be hereinafter called the client device and described. The client device 100 is operated by a remote controller 400. The remote controller 400 can perform operations of powering on or off, initial setting, channel selection, volume control, image quality control, etc., on the client device 100.

The client device 100 is connected to, for example, a home local area network (LAN). Server 500 is connected to the LAN. A system for providing a remote user interface (which may be abbreviated as remote UI) through the LAN is constructed between the client device 100 and server 500. Server 500 may be a set-top box.

The following operations are executed in a remote UI system. For example, an operation button of the remote controller 400 indicated by “program guide (P-table)” is operated by the user to display a program guide in the client device 100. Then, a control command corresponding to a “program guide (P-table)” operation button is transmitted to server 500. Server 500 transmits an instruction command for a remote UI to the client device 100 in response to the control command. This instruction command may be data including a remote UI image (in this case, program guide image) and an area ID (identification information of display area) for specifying a display position of the remote UI image. Alternatively, the client device 100 may generate a UI image based on an instruction command including display position information. The client device 100 operates to display a program guide on a screen in accordance with the instruction command in this manner. The remote UI image may be called graphics data. The area ID (identification information of display area) may be referred to as a buffer ID.

The client device 100 renders the UI image based on received display position information, and displays the remote UI image. The remote UI image is, for example, a program guide image in this case, and includes a cursor image. The cursor is displayed on the screen.

Next, the user selects a desired program from the program guide. Suppose the user presses an operation button for cursor operation of the remote controller 400 to move a cursor. Then, the client device 100 transmits a control command corresponding to the operation button to server 500. Server 500 analyzes the received control command, and replies an instruction command for executing the movement of the cursor (instruction command for specifying a display position of a cursor image) to the client device 100. The television client device 100 changes a cursor display position on the screen in accordance with the instruction command.

As described above, the client device 100 constructs the remote UI system between the client device 100 and server 500. However, server 500 is connected to external server 600 through an external network such as the Internet. Thus, the client device 100 may construct a system similar to the remote UI system between the client device 100 and server 600. That is, server 600 may have a function similar to that of server 500.

Furthermore, the client device 100 sometimes mutually communicates with an external device (server) irrelevant to servers 500 and 600. For example, it sometimes receives information uniquely from server 610 for service through the Internet. The information includes, for example, a list of programs recommended by friends, that is, information called “Recommendation by friends” and a list of programs popular among friends, that is, information called “Popular among friends”. The user can use such information for selecting a program to be viewed by the user. Other information includes information indicating how many friends currently view a program identical to that viewed by the user (for example, program B). The user can talk about the program when meeting their friends later with respect to the program acquired from such information.

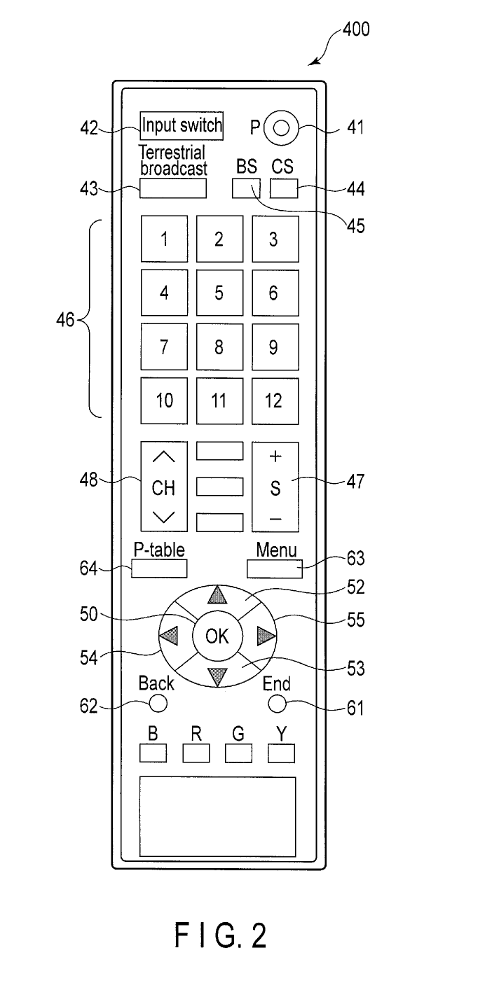

FIG. 2 schematically shows an example of the remote controller 400. The remote controller 400 comprises a power button 41, an input switching button 42, a terrestrial broadcast button 43, a CS broadcast button 44 and a BS broadcast button 45.

It also comprises a button group 46 consisting of numbers 1-12, a volume button 47, a channel change button 48, etc. Furthermore, button 50 is an OK button. Buttons 52 and 53 are buttons indicating directions, and used to, for example, move a cursor. Button 62 is a back button, and is an operation button for returning a menu screen, etc., of a client device to the previous screen state. Button 61 is an end button.

Moreover, button 63 indicated by “Menu” is an operation button for shifting to the menu screen. Button 64 indicated by “P-table” is an operation button for shifting to program guide display.

As described above, a so-called operation guide indicating a function of a button which is described around the button enables the user to easily select the button as necessary.

The remote controller 400 includes, for example, a plurality of buttons B, R, G and Y with different colors and the same shape (so-called uncertain or undefined buttons). When seeing the buttons, the user is unable to understand, without an operation guide, what action the client device (television receiver) will take after each of the buttons is operated. That is, the user cannot have the confidence to operate the uncertain button.

Since one embodiment allows the operation guide of the uncertain button as described above to be adaptively provided on the screen, the user can have the confidence to operate buttons B, R, G and Y. This will be described later in detail.

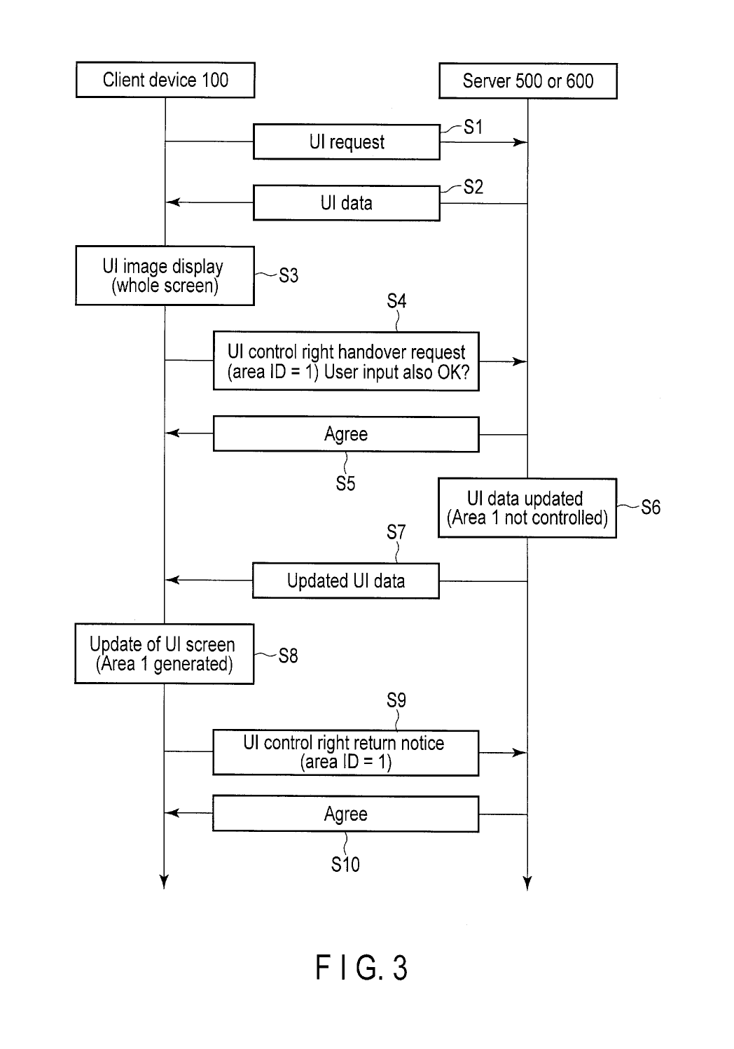

FIG. 3 is an explanatory chart of an operation example of a remote UI system constructed between the client device 100 and server 500 or 600. Suppose the program guide is displayed in the client device 100. The user operates the operation button of the remote controller 400 indicated by “program guide (P-table)”.

Then, a control command corresponding to “program guide (P-table)” operation button is transmitted to server 500 (step S1 for UI request).

Server 500 transmits an instruction command for a remote UI to the client device 100 in response to the control command (UI request) (UI data transmitting step S2).

The client device 100 renders a UI image based on received display position information, and displays a remote UI image (UI image displaying step S3). That is, server 500 transmits it to the client device 100 with each UI image associated with the display position information (area identification data, area ID) indicating an area to be displayed. The client device 100 arranges each UI image in an area indicated by the area ID, and displays the remote UI image.

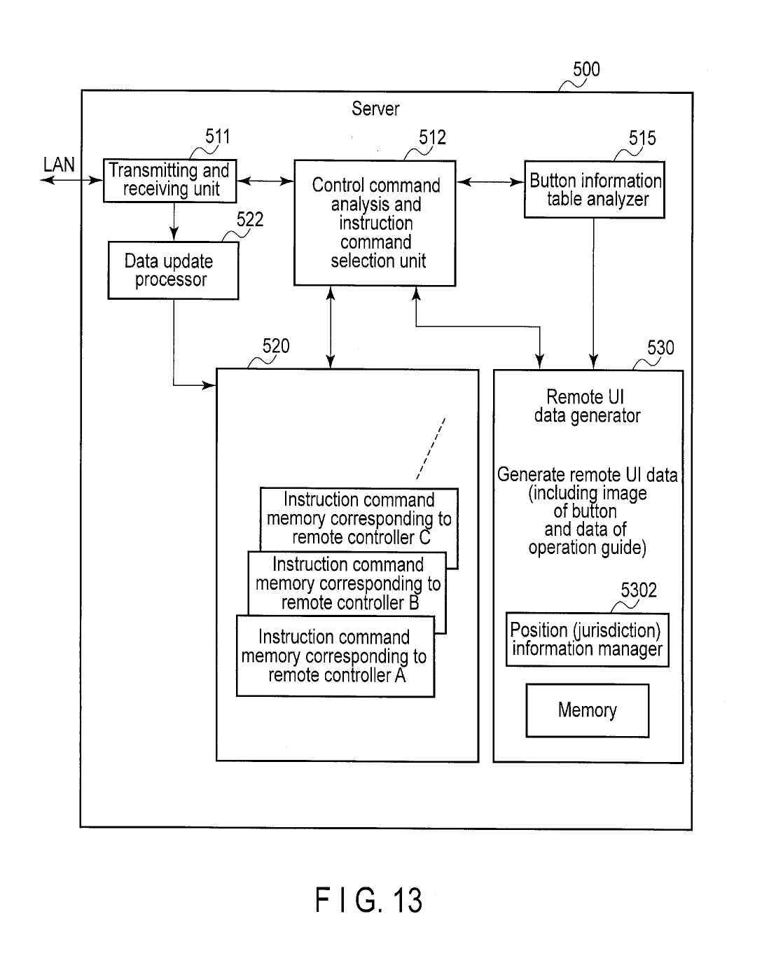

Server 500 acquires an area size of a display screen of a display included in the client device 100, that is, information on resolution from the client device 100 before at least step S2. Then, server 500 divides a display screen area into a plurality of areas, and adds an ID to each area. Server 500 transmits UI data to the client device 100 with an image part displayed in the client device 100 associated with the area ID. As will be described with reference to FIG. 13 later, the number of areas obtained by the division and the shape, size, etc., of each area can differ depending on the situation.

Next, the client device 100 can transmit a UI control right handover request (request for right of use of some area on screen, for example, area 1) to server 500 in the present embodiment. The area in which the right of use is requested is pre-designed in the client device 100 for each screen (program guide screen, program display screen, etc.) or for each event (message reception, etc.). In this example, the right of use of area 1 corresponding to the program guide screen is requested. However, the method of requesting the right of use of area 1, 2 or 3 is not limited to the above method. A requested area may be determined by area identification data (area ID) issued by the client device 100 based on the operation button. For example, area 1 is determined based on the “program guide (P-table)” operation button, and the right of use of area 1 may be requested.

That is, the client device 100 can request the right of use of some area (or a part of area) on the screen to server 500 based on unique control. The client device 100 can request the handover of the right of use of another area, for example, area 2 or 3 by changing the area ID. Thus, the UI data of server 500 does not always control the whole screen of the client device 100 based on the display position information. That is, the screen of the client device 100 is under the control of server 500, but the right of use of some area is transferred to the client device 100.

Further, the client device 100 can make a request such that a user input for operating the device can be performed in an area permitted to be used, along with the UI control right handover request (step S4). That is, the client device 100 can request both a control right of screen update in an area and an exclusive control right of a user input in the area.

The client device 100 may request only one of the control rights. If the client device 100 receives the control right of the screen update in an area, it displays an image unique to the client device 100 in the area. Further, if the client device 100 receives the exclusive control right of the user input in an area, it processes the user input in the client device 100 without transmitting the user input in the area to server 500.

If the UI control right handover request is received, server 500 transmits an approval (agreement) signal to the client device 100 (step S5). Server 500 updates the UI data (shifting from whole screen control (or dominate) to partial screen control (or dominate)) such that the client device 100 can secure, for example, area 1 (step S6). The updated UI data is transmitted to the client device 100 (step S7).

Thus, the UI screen of the client device 100 is updated, and area 1 is secured. The whole screen comprises a first area secured based on the UI data (for example, image display area of program guide) and a second area secured based on a unique operation of the client device 100 (generated image display area unique to client device) (step S8).

That is, the client device 100 comprises a receiver configured to acquire the UI data from the server (external device) and a first guide image generator configured to display a first guide image generated based on the UI data in the first area of the display. Further, the client device 100 comprises a second guide image generator configured to display a second guide image generated based on the unique operation in the second area different from the first guide image of the display.

When the first and second guide images are displayed, and no operation input is received from the remote controller 400, for example, for a given period, the client device 100 transmits a UI control right return notice to server 500 (step S9). After receiving the UI control right return notice, server 500 transmits the approval (agreement) signal to the client device 100 (step S10). Then, the screen of the client device 100 returns to, for example, the display state before step S1.

Although server 500 transmits the remote UI image or remote UI data to the client device 100 upon receipt of the remote UI request in the above description, the timing is not limited to this. It can be pre-transmitted before the request. If the remote UI image is pre-transmitted from server 500 to the client device 100 and is stored in a storage, the client device 100 displays the remote UI image in accordance with a display instruction from server 500 upon receipt of the instruction.

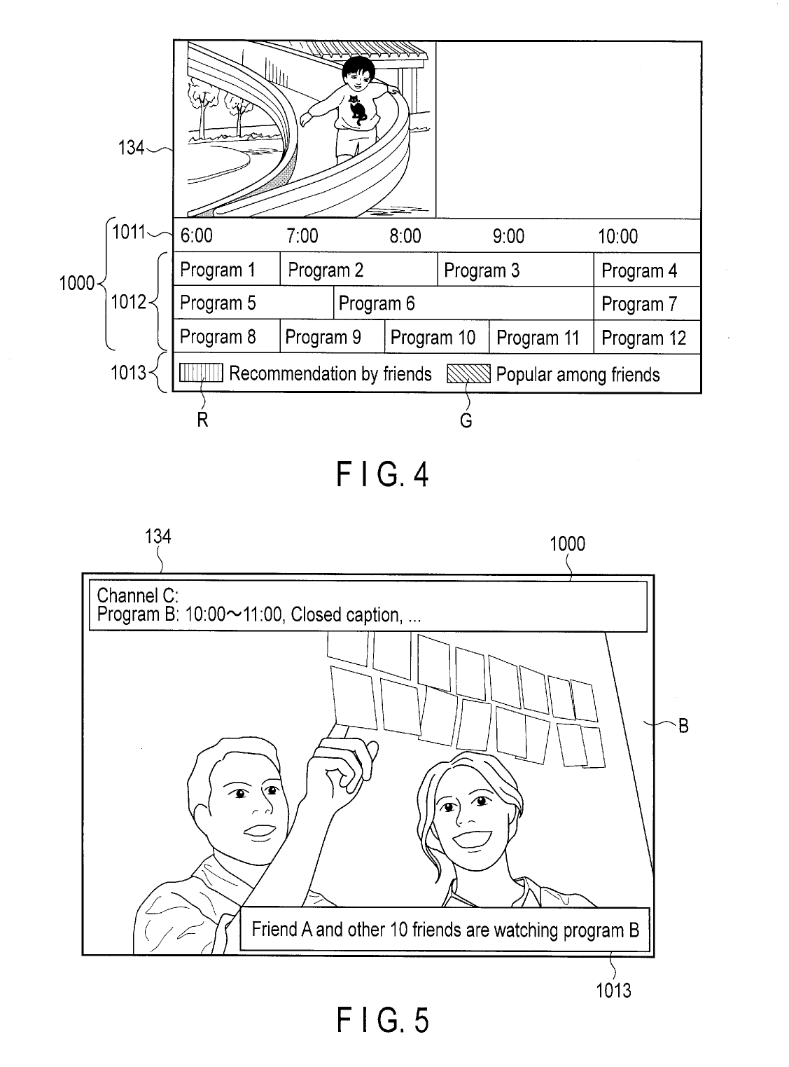

FIG. 4 shows an example of a screen of a display 134 of the client device 100. FIG. 4 shows an example in which the program guide is displayed in a first area 1000 based on the operation of the “program guide (P-table)” operation button. The program guide can be displayed even if, for example, “program guide” which is an item in a menu displayed on the screen is selected, and the OK button is pressed.

The program guide includes a time display area 1011 and a program name display area 1012. In the figure, programs are named programs 1 to 12 for simplification. Actually, the names of programs and performers, etc., are described. Further, a day of the week, that is, Monday, Tuesday, Wednesday, . . . , Sunday, is displayed on the left side of the program guide, but does not appear in the figure. The user can scroll the program guide using a scroll button of the remote controller to see the day of the week.

In addition, an operation button and a guide are displayed as an image in, for example, area 1013 in the lower portion of the screen. Area 1013 is the above-described second area, and FIG. 4 shows that the above-described second guide image is displayed in this second area.

The second guide image is not displayed based on the UI data from server 500, but is uniquely generated by the client device 100.

In the example of this image, “Recommendation by friends” is displayed as a guide corresponding to red button R. This means that a list of programs recommended by friends can be displayed by pressing red button R. Thus, when the user presses button R of the remote controller, the list of programs recommended by their friends is displayed. Then, the user can select a desired program from the program list using a cursor and press a determination button to reproduce the desired program.

Further, “Popular among friends” is displayed as an operation guide corresponding to green button G. This means that a list of programs popular among friends can be displayed by pressing green button G. Thus, when the user presses button G of the remote controller, the list of programs popular among friends is displayed. Then, the user can select a desired program from the program list using a cursor, and press the determination button to reproduce the desired program.

As described above, the second guide image generator can include the operation button (buttons R and G) and/or operation guide (“Recommendation by friends” and “Popular among friends”) which are likely to be operated by the user in the second guide image with respect to an arbitrary operation button (for example, “program guide” operation button) in the present embodiment.

As described above, the client device 100 can display the first guide image received from server 500 (external device) and the second guide image (which may be called a local UI image) generated by the client device 100 based on a unique operation. The displayed second guide image enables the user to operate a device in various ways and to freely operate the client device.

In the above second guide image, en example of a program list image is displayed. However, the above second guide image is not limited to such an image. It may be an image for setting the client device using the operation button and/or operation guide which are likely to be operated by the user. For example, it may be an image for indicating some setting items of the device using the operation button and/or operation guide. The setting items include, for example, a luminance adjustment item of the image of the client device, a color adjustment item, a timer item, a program recording reservation item and a viewing reservation item. Further, the setting items include an initial setting item of the item client device 100, etc. These items are items for setting control data regarding a unique operation of the client device 100.

The client device 100 sometimes receives information from an external device (server or cloud) 610 (refer to FIG. 1) as well as server 500. In such a case, not only the area of the first guide image controlled by server 500 but also a display area (second area) of the second guide image should be secured.

Then, if the client device 100 of the present embodiment receives information from the external device (server) 610 (refer to FIG. 1) different from server 500 or 600, the display area (second area) of the second guide image can be automatically secured. The method of securing the second area is described with reference to FIG. 3.

As described above, the display area controlled by server 500 and that controlled by the client device 100 are simultaneously secured in the display of the client device 100 in the present embodiment. Normally, server 500 can manage and control all area of the display of the client device 100 by dividing the area into small areas based on position information. However, when receiving the UI control right handover request from the client device 100, server 500 can release the control of the area according to the request to the client device 100, and, as described above, hand over some control area (second area) to the client device 100. Since the client device 100 can request a display area to be controlled to server 500 as an arbitrary area ID (part), the second area is not limited to the position shown in the figure.

The method for obtaining the display of the operation guide (“Recommendation by friends” or “Popular among friends”) is not limited to the above-described method. For example, the user operates button 63 for menu display (shown in FIG. 2) of the remote controller 400. Then, a menu image is displayed. In the menu image, for example, “Recommendation by friends” and “Popular among friends” are displayed as selection items. The user operates the remote controller 400, selects a desired item using a cursor, and presses a determination button. This causes a list of programs recommended by friends or a list of programs popular among friends to be displayed on the display.

FIG. 5 shows an example in which other first and second guide images are displayed at the same time. This example indicates a state where program B is displayed on the whole screen of the display 134, the first guide image is displayed in the first area 1000, and the second guide image is displayed in a second area 1013.

This occurs when, for example, information is received from the external device (server) 610 (refer to FIG. 1) different from server 500 or 600. If, for example, information “Friend A and other 10 friends are watching program B” is received from server 610, the client device 100 requests authority of the second area 1013 to server 500. When the request is accepted, the client device 100 generates the image of this message (local UI) and displays it in the second area 1013. This enables the user viewing program B to know that their friends are viewing program B at the same time. Although detailed information on program B is displayed in the first area 1000, the detailed information may be transmitted from server 500 independently from server 610, or received from server 500 in accordance with a notice from server 610 as will be described below. For example, when information is received from server 610 as described above, the client device 100 notifies server 500 that information is received from server 610 (information concerning the number of friends viewing program B and the program currently being viewed). Then, server 500 replies with detailed information on the program currently being viewed by the client device 100 as UI data. This detailed information (for example, Channel C; Program B; 10:00-11:00, Closed caption, . . .) is displayed in the first area 1000. This enables the user to correctly recognize a broadcast channel, a broadcast period, a program attribute, etc., of the program currently being viewed. Further, the number of friends viewing the same program and specific friend A can be recognized. The first and second guide images disappear when a given period expires.

Also in this embodiment, a display area controlled by server 500 and that controlled by the client device 100 are simultaneously secured in the display of the client device 100. Since the client device 100 can request a display area to be controlled to server 500 as an area ID (part), the second area is not limited to the position shown in the figure.

If the user positively desires the second guide image independently from the first guide image, the client device 100 can uniquely access server 610. For example, the user operates button 63 for menu display (shown in FIG. 2) of the remote controller 400. Then, a menu image is displayed. In the menu image, for example, “currently viewing friends” is displayed as a selection item. The user operates the remote controller 400, selects a desired item using a cursor, and presses a determination button. This allows information concerning the number of the currently viewing friends, etc., to be received.

As described above, the second guide image generator includes an operation button and/or an operation guide which are likely to be operated by the user in the second guide image if a notice is received from server 610 different from the external device. The operation button and/or the operation guide which are likely to be operated by the user are information concerning another electronic device connected to server 610.

Next, another embodiment enabling the user to operate an electronic device more easily in various ways and to more freely operate the electronic device will be described.

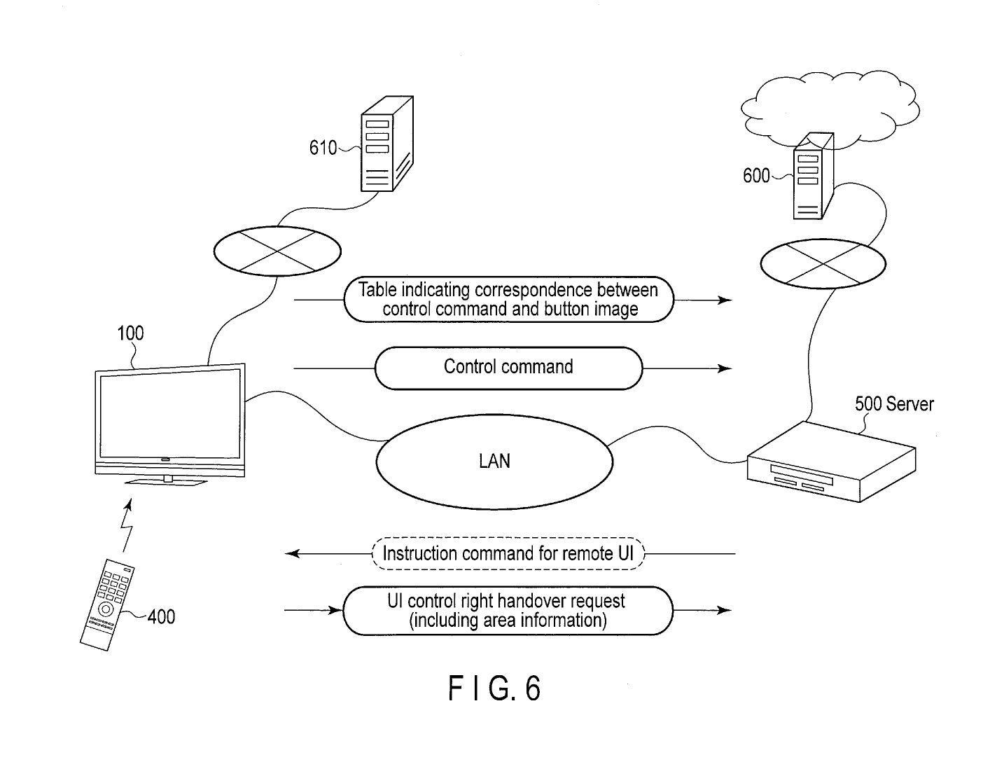

FIG. 6 shows a typical configuration example of an electronic device control system according to another embodiment. The system of FIG. 6 is different from that of FIG. 1 in that the client device 100 of FIG. 6 further comprises means for pre-transmitting a button information table indicating a correspondence between a control command and an operation button to server 500. Server 500 can store the button information table. Then, the client device 100 transmits an ID of an operation button to server 500 when the operation button is operated by the remote controller 400. Server 500 refers to the button information table, determines the control command based on the ID, and transmits an instruction command corresponding to this control command to the client device 100. The instruction command can include an image of the operation button and data of the operation guide (which will be described with reference to FIG. 8 later). The client device 100 operates based on the received instruction command. This causes the client device 100 to operate in accordance with the operation button.

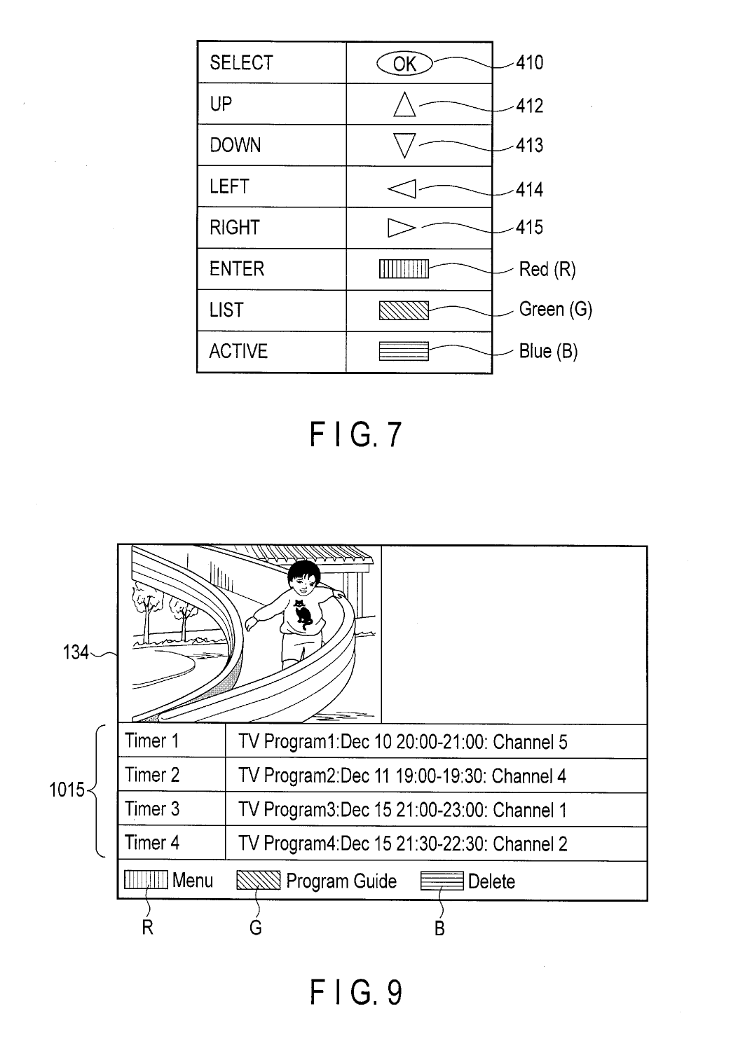

FIG. 7 shows a button information table indicating a correspondence between the control command and the operation button pre-transmitted to server 500 by the client device 100. This table shows a correspondence between the control command and a button image. In this button information table, image 410 of the OK button of the remote controller is associated with control command SELECT. Image 412 of an upward triangular button of the remote controller is associated with control command UP. Image 413 of a downward triangular button of the remote controller is associated with control command DOWN. Image 414 of a leftward triangular button of the remote controller is associated with control command LEFT. Image 415 of a rightward triangular button of the remote controller is associated with control command RIGHT. Image R of a red rectangular button of the remote controller is associated with control command ENTER. Image G of a green rectangular button of the remote controller is associated with control command LIST. Image B of a blue rectangular button of the remote controller is associated with control command ACTIVE.

FIG. 8 shows a typical example in which an operation guide transmitted from server 500 to the client device 100 is displayed in the embodiment of FIG. 6. FIG. 8 shows an example in which the image shown in FIG. 4 has changed after a given period. In the description regarding FIG. 4, a local remote UI image of the second area 1013 is controlled by the client device 100. However, when the given period expires, the UI control right of the second area 1013 is returned to server 500, and thus, the second area 1013 becomes under the control of server 500.

At this moment, server 500 displays a program guide in the first area 1000, and an operation button and an operation guide are displayed in the second area 1013 in the lower portion of the screen as images. In this example, “Contents list” is displayed in the second area 1013 as the operation guide corresponding to red button R. This means that a content list can be displayed by pressing red button R. For example, when the user operates the remote controller, specifies a desired time using the cursor and presses button R of the remote controller, a list of programs, for example, during the specified period is displayed.

Further, “Interactive portal” is displayed as the operation guide corresponding to green button G. This means that pressing green button G changes the state to, for example, an interconnected state with other devices. The other devices are, for example, other client devices and recording reproducing devices, which are connected through a home local area network (LAN).

This enables the user to easily understand which uncertain operation button (red button R or green button G) can be operated, and what operation result is obtained by operating the button (that is, action of the electronic device) in a state where the program guide is displayed.

This enables the user to easily operate the electronic device with confidence in various ways. Further, this enables the user to freely operate the electronic device. Sometimes, numbers, “channel”, “volume”, “mute”, “CS”, “BS”, etc., are described on the surfaces of the operation buttons as types of operation button. On seeing the above types of operation button, the user can intuitively understand the action of the electronic device to be taken after the operation button is pressed.

However, the remote controller 400 may include a plurality of operation buttons with the same shape and different colors. The user sometimes cannot intuitively understand the action of the electronic device to be taken after this type of operation button (which may be called, for example, an ambiguous operation button, an undefined operation button and an uncertain operation button) is pressed. Moreover, such an uncertain operation button sometimes prevents the user from recognizing the presence of the function of the electronic device concerning the uncertain operation button.

However, as described above, server 500 manages the button information table in the present embodiment. When server 500 becomes able to manage the second area 1013, images of the operation button and operation guide can be displayed in the client device 100 based on the control of server 500.

Thus, when the operation button is operated, the operating action of the client device 100 in response to the operation button can be easily recognized. Then, the user can operate the electronic device in various ways.

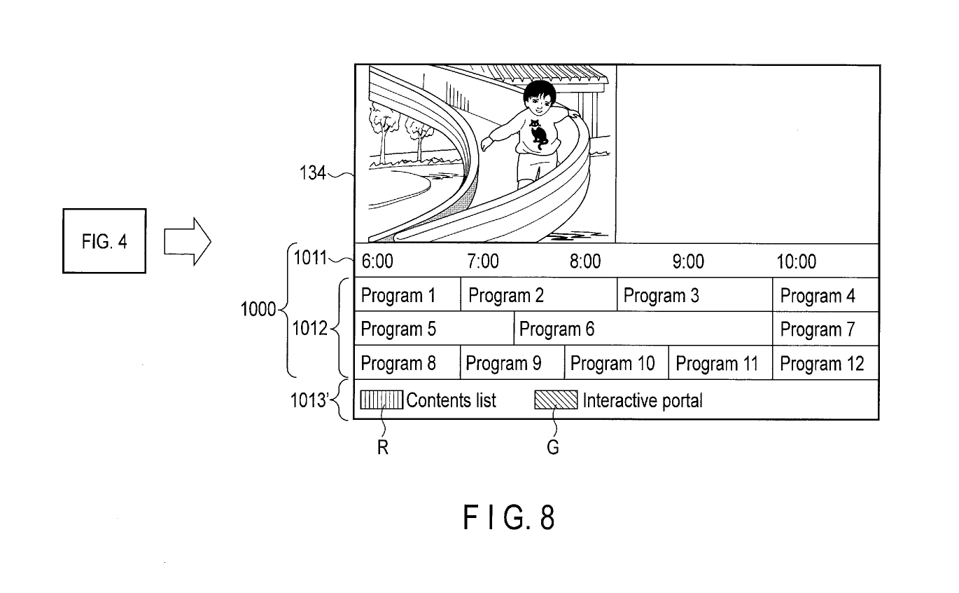

FIG. 9 shows another example in which an operation guide transmitted from server 500 to the client device 100 is displayed in another embodiment. Suppose a recording reservation list 1015 is displayed in the display 134 of the client device 100. The recording reservation list 1015 is displayed when, for example, “recording reservation list” which is an item (operation button) in the menu displayed on the screen is selected, and the OK button is pressed.

Server 500 receives a notice indicating that operation button “recording reservation list” is selected through a LAN.

In the figure, TV programs 1-4 and a date, a time and a channel of recording reservation of each program are indicated in Timers 1-4 of the recording reservation list 1015. This example is simplified. In reality, names of a program and a performer, etc., are described in each of TV programs 1-4. Furthermore, the images of red button R, green button G and blue button B are displayed in the area below the recording reservation list 1015. “Menu” is displayed next to button R, “Program Guide” is displayed next to button G, and “Delete” is displayed next to button B.

This means that pressing button R shifts the client device to a menu display state, pressing button G shifts the client device to a program guide state (state shown in FIG. 8), and pressing button B deletes a program, when the recording reservation list 1015 of FIG. 9 is displayed.

When button B is used, the user operates the remote controller in advance, and points the cursor to a reserved program to be deleted. Then, the user presses button B. This cancels the selected reserved program.

In the above embodiment, the recording reservation list 1015 may be uniquely displayed by the client device 100. Alternatively, its display image data may be provided from server 500. However, buttons R, G and B and the image of the guide (comments) associated with each of buttons R, G and B are provided by server 500. The display image data of the recording reservation list 1015 provided from server 500 is based on the premise that recording reservation data of the client device 100 is pre-transmitted to server 500.

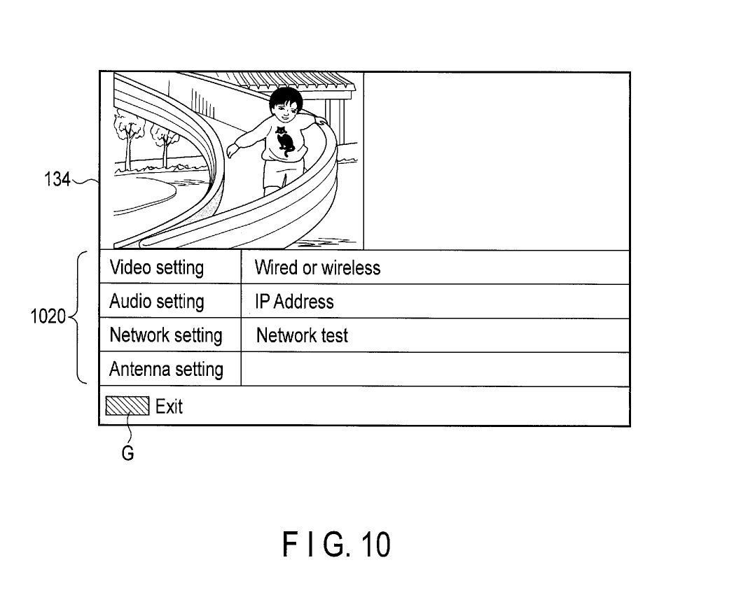

FIG. 10 shows yet another typical example in which an operation guide transmitted from a server to a client device is displayed in another embodiment. In this example, an item group 1020 for various settings is displayed on the screen of the client device 100. This display state is realized when, for example, item “setting” is selected in the menu display state, and the OK button is pressed.

The setting items include, for example, “Video Setting”, “Audio Setting”, “Network Setting” and “Antenna Setting”. These are part of the items, and are representatively shown. Other setting items are displayed by a scroll operation. If “Video Setting” is selected and determined, the screen can be shifted to, for example, a setting screen for determining whether video is received by wire or wireless. If “Audio Setting” is selected and determined, the screen can be shifted to a setting screen for determining an IP address for transmitting and receiving audio. If “Network Setting” is selected and determined, the screen can be shifted to a screen for testing a network.

Green button G is displayed on this screen. “Exit” is described next to button G. This means that pressing green button G returns all screens to a program display state.

The item group 1020 may be uniquely displayed by the client device 100. Alternatively, the display image data of the item group 1020 may be provided from server 500. However, button G and the image of the guide (comments) associated with button G are provided by server 500. The display image data of the item group 1020 provided from server 500 is based on the premise that data of the item group 1020 of the client device 100 is pre-transmitted to server 500.

As described above, this embodiment allows the operation guide of the uncertain button to be adaptively provided on the screen, and enables the user to effectively utilize buttons B, R, G, etc.

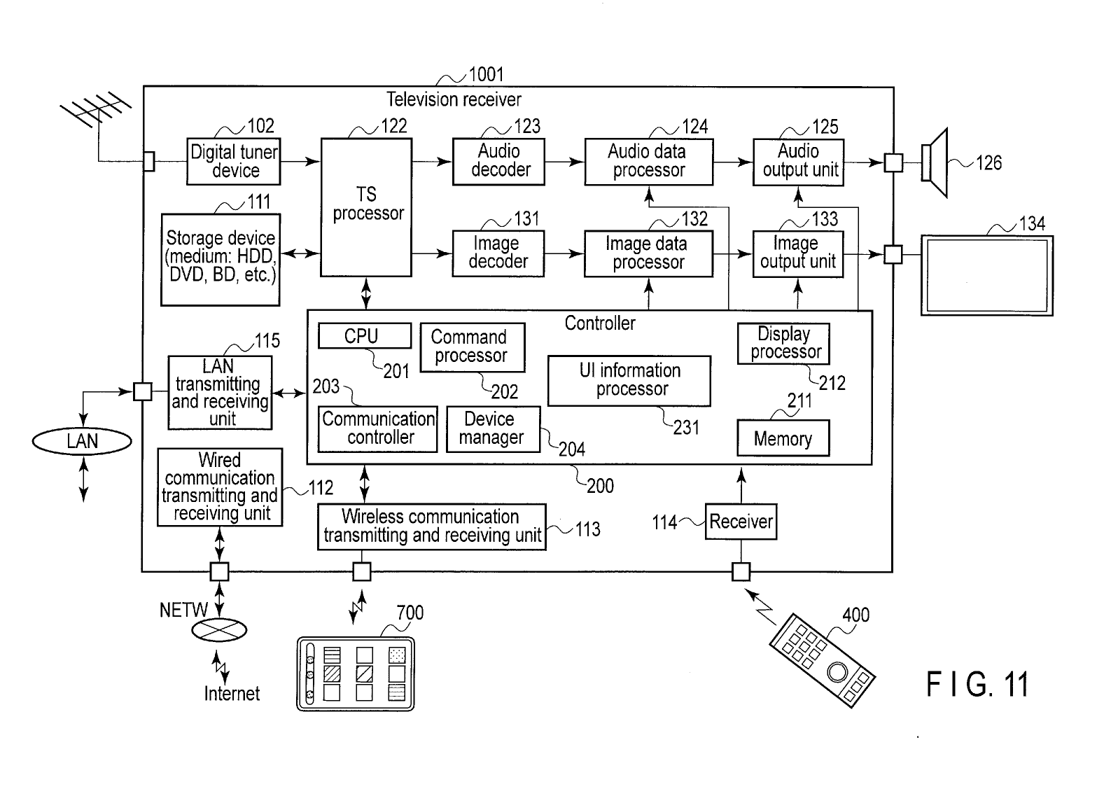

FIG. 11 shows a typical configuration example of the client device (television receiver) 100 according to an embodiment. Although the configuration of the client device is shown in the present embodiment, the client device 100 is not necessarily limited to the client device.

The client device 100 comprises a tuner device 102, and the tuner device 102 includes a plurality of tuners configured to receive, for example, a scrambled digital terrestrial broadcast signal. The tuner device 102 may include, for example, a tuner (not shown) for transmitting and receiving broadcasting satellite (BS) or communication satellite (CS) digital broadcast.

A signal of a broadcast program received in the tuner device 102 is input into a TS processor 122, and transport streams (TSs) of a plurality of channels (CH) are remultiplexed into one TS, which will be a multiplex TS. Multiplex TS multiplexes a packet train of a broadcast program of each channel. A channel and identification information for packet identification are added to a packet of each channel.

Multiplex TS is input into a recording reproducing device 111. A packet including control information is input into a controller 200 and processed in a TS input into the TS processor 122.

The recording reproducing device 111 includes, for example, a hard disk drive and/or an optical disk recording reproducing device. A Digital Versatile Disk (DVD), a Blu-ray disk (registered trademark) (BD), or the like is adopted as the optical disk. The recording reproducing device 111 can record and reproduce the multiplex TS.

The packet transmitted from the TS processor 122 to the controller 200 includes information such as a program association table (PAT) which is program sequence information, a program map table (PMT) including packet identification information on a transport packet, an entitlement control message (ECM) which is encrypted information of a broadcast program and an event information table (EIT) which is a table describing event information such as names of a program and a performer and a starting time, and electronic program guide (EPG) information.

The image data included in a packet is encoded by, for example, a Moving Picture Expert Group (MPEG) method, an Advanced Video Coding (AVC) method, etc. Further, audio data in an audio packet is encoded by, for example, a pulse code modulation (PCM) method, a Dolby (registered trademark) method, an MPEG method, etc. An AV decoder 126 separates an image packet and an audio packet in a program, and decodes data in each packet by a decoding method corresponding to each encoding method.

Thus, the packet including the audio data in the packet separated in the TS processor 122 is input into an audio decoder 123, and decoded in accordance with encoding methods. Synchronization processing, volume control, etc., are performed on the audio data decoded by the audio decoder 123 in an audio data processor 124, and the audio data is supplied to an audio output unit 125. The audio output unit 125 executes separating processing of a stereo signal, etc., in accordance with a speaker system, and supplies an output to a speaker 126.

The packet including the image data in the packet separated in the TS processor 122 is input into an image decoder 131, and decoded in accordance with encoding methods. Synchronization processing, luminance adjustment, color adjustment, etc., are performed on the image data decoded by the image decoder 131 in an image data processor 132. The output of the image data processor 132 is supplied to an image output unit 133. The image output unit 133 can multiply data, a figure, a program guide, etc., from the controller 200 to a main image signal. Further, the image output unit 133 sets a scale, resolution, the number of lines, an aspect ratio, etc., in accordance with the display 134 for the output image signal, and outputs them to the display 134.

The audio packet and image packet of a pay program are sometimes encrypted. In this case, a processing system for decryption using key information is present. However, it is here omitted.

The controller 200 includes a central processing unit (CPU) 201, an operation command processor 202, a communication controller 203, an operation device manager 204, a display processor 212 and a memory 211. Furthermore, it includes an electronic program guide (EPG) data processor, a record controller, etc., which are not shown.

The CPU 201 controls an operation sequence of the whole controller 200. The operation command processor 202 can analyze an operation command input from the outside to reflect the operation in accordance with the command in the client device 100.

The operation device manager 204 can grasp and manage device identification data of a mobile terminal 700, the remote controller 400, etc., which provide the controller 200 with an operation signal.

The display processor 212 can generally control the image signal displayed in the display 134 through the image output unit 133. Further, the display processor 212 can also adjust resolution of the image signal, a display size, a display area, etc. Further, it can supply the image signal of the program guide prepared using the EPG data and a menu image signal prepared in the controller 200 in accordance with an operation signal to the image output unit 133. The memory 211 can store various types of data, application, etc., stored in the controller 200.

The communication controller 203 is connected to a wired communication transmitting and receiving unit 112, a wireless communication transmitting and receiving unit 113, a receiver 114 and a LAN transmitting and receiving unit 115.

The communication controller 203 can transmit data, content, etc., from the client device 100 to the outside. Further, the communication controller 203 can also transmit the above-described button information,' control command, etc., to server 500.

Further, the communication controller 203 can receive an instruction command, etc., for content data, control data and a remote UI from the outside through the wired communication transmitting and receiving unit 112, the wireless communication transmitting and receiving unit 113, the receiver 114 and the LAN transmitting and receiving unit 115.

Taken-in content, data, command, etc., can be stored in, for example, the recording reproducing device 111 or the memory 211.

The wireless communication transmitting and receiving unit 113 can transmit and receive data between a plurality of mobile terminals 700, and is used for short-distance communication. The mobile terminal 700 can also remotely control the client device 100. The mobile terminal 700 can access a server through a base station (not shown), the Internet, etc. The mobile terminal 700 can download content, various types of application and game software, etc., from the server, and transfer them to the controller 200 through the wireless communication transmitting and receiving unit 113. Further, the mobile terminal 700 can transfer information for acquiring content (for example, address of web server, e-mail address, network address) to the controller 200 through the wireless communication transmitting and receiving unit 113.

The communication controller 203 operates when the content, application or game software is transferred from the mobile terminal 700. The communication controller 203 stores the received content in the memory 211. The content may be stored in the recording reproducing device 111 in accordance with an operation command or automatically. The recording reproducing device 111 can record the received content in, for example, a hard disk. The content is managed as a content file in the hard disk.

Further, the communication controller 203 can also receive the operation signal from the remote controller 400 through the receiver 114.

The wired communication transmitting and receiving unit 112 can transmit and receive data between remote servers through the Internet. The client device 100 may be connected to the Internet by wireless communication as well as by wired communication.

The menu image signal, program guide image signal, etc., for display are stored and/or managed in the display processor 212. When the menu or program guide is displayed, the menu screen data or program guide image signal is read from data storage (memory or hard disk), a UI information processor 231, etc., based on control of the display processor 212, and supplied to the image output unit 133. This causes the menu image or program guide image to be displayed in the display 134.

The image signal of the menu for display, that of the program guide for display, or the like can also be transmitted to the mobile terminal 700. If the mobile terminal 700 requests the image signal of the menu, that of the program guide, or the like, the communication controller 203 can transmit the image signal of the menu or that of the program guide to the mobile terminal 700.

The mobile terminal 700 can display the image signal of the menu or that of the program guide on a touchpanel screen, and the user can touch an operation button displayed on the touchpanel screen (or point screen) to instruct the TV device to operate.

The LAN transmitting and receiving unit 115 is connected to a home LAN.

The controller 200 includes a characteristic UI information processor 231. The UI information processor 231 is closely related to the description made with reference to FIGS. 1 to 10.

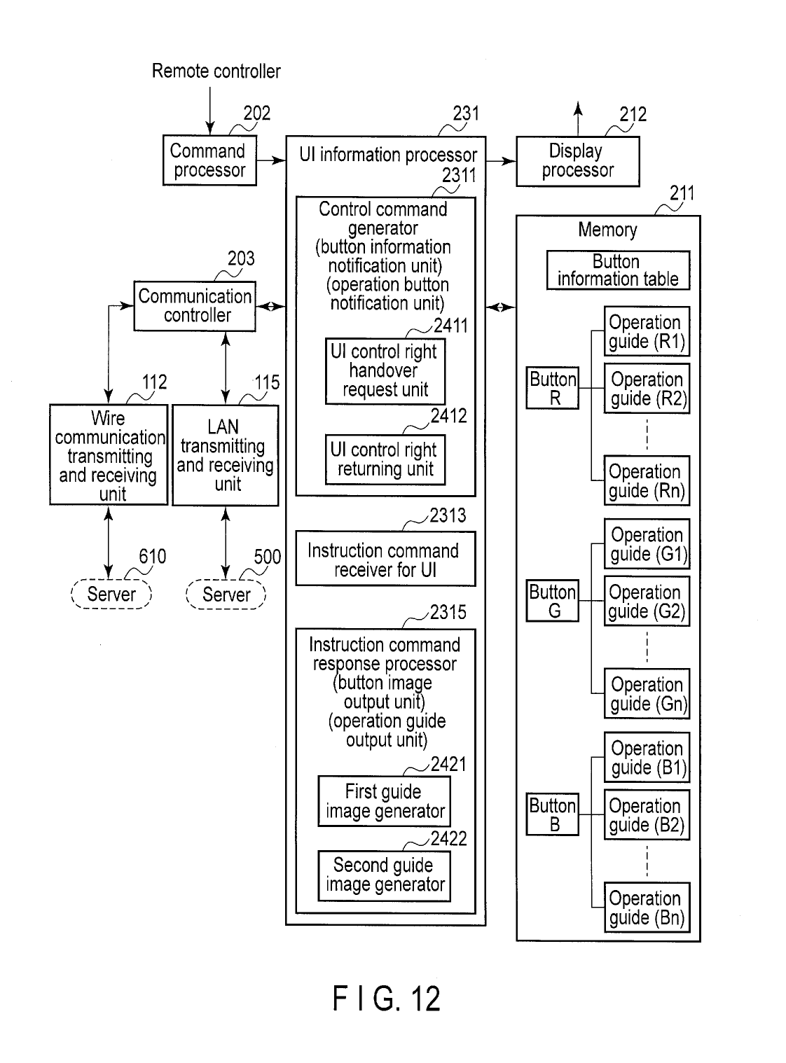

FIG. 12 shows a typical configuration example of a controller of the client device shown in FIG. 11. However, the configuration of the UI information processor 231 or related blocks thereof are not limited to the configuration shown in FIG. 12. A block such as the UI information processor 231 may be realized by software in the controller 200. The UI information processor 231 includes a control command generator 2311, an instruction command receiver 2313 for the remote UI, an instruction command response processor 2315, etc.

The control command generator 2311 includes a button information notification unit for notifying a server of the button information table, and an operation button notification unit for notifying the server of the operated operation button. The button information notification unit may be called a button information table notification unit. Further, the control command generator 2311 can include a UI control right handover request unit 2411.

The instruction command receiver 2313 acquires user interface (UI) data from server 500 when communication with server 500 is performed in accordance with the operation of an arbitrary operation button. Further, the instruction command receiver 2313 can receive and analyze information also when the information is provided from server 610.

The instruction command response processor 2315 includes a button image output unit for selecting the image of the operation button from the memory and outputting it to the display, and an operation guide output unit for selecting the operation guide corresponding to the button from the memory and outputting it to the display.

Moreover, the instruction command response processor 2315 includes a first guide image generator 2421 configured to display the first guide image generated based on the remote UI data in the first area of the display 134, and a second guide image generator 2422 configured to display the second guide image generated based on the unique operation of the client device 100 in the second area different from the first guide image of the display 134.

The operation signal generated based on the operation of the remote controller 400 is analyzed in the command processor 202, and processed in the UI information processor 231. The UI information processor 231 can output related data corresponding to the operation signal (button information table, control command, or the like) to server 500. The related data is transmitted to server 500 through the communication controller 203 and the LAN transmitting and receiving unit 115.

The UI information processor 231 reads the button information table (button information table shown in FIG. 7) from the memory 211 and transmits it to server 500 in conjunction with, for example, the input of an operation signal for powering on the client device. The identification information on the client device and/or the remote controller 400 is also transmitted to the server.

Thus, server 500 can recognize the function of the operation button included in the button information table, and construct the operation guide for the recognized function.

Each function of the operation button of the remote controller and related data concerning each operation guide corresponding to each function may be prestored in server 500.

In a first example, each function of each operation button of the remote controller and each operation guide corresponding to each function may be prestored in server 500. Alternatively, each function of each operation button of the remote controller and identification data of each operation guide corresponding to each function may be prestored in server 500. In this case, an operation button and an operation guide corresponding thereto is selected from the memory 211 in accordance with the identification data.

In the memory 211, a plurality of operation guides R1 to Rn are prepared with respect to button R, a plurality of operation guides G1 to Gn are prepared with respect to button G, and a plurality of operation guides B1 to Bn are prepared with respect to button B. One of operation guides is selected for one button in accordance with content of the displayed remote UI image. In the example of FIG. 8, the remote UI image is a program guide. In this case, operation guide “Contents list” is selected for button R, and operation guide “Interactive portal” is selected for button G. Further, in the example of FIG. 9, the remote UI image is a recording reservation list. In this case, operation guide “Menu” is selected for button R, operation guide “Program Guide” is selected for button G, and operation guide “Delete” is selected for button B.

Suppose the remote controller is operated and the display of “program guide” is requested. The control command generator 2311 generates a control command indicating that the display of “program guide” is requested. This control command is transmitted to server 500. Server 500 replies an instruction command to the client device 100 in response to the control command. The instruction command is analyzed in the instruction command receiver 2313. Then, the instruction command response processor 2315 operates in accordance with analysis content of the instruction command.

For example, server 500 transmits the remote UI data (or image) of “program guide” shown in FIG. 4 to the client device 100 in response to the control command, and instructs the client device 100 to display the remote UI image. Then, the client device 100 can execute the operation described with reference to FIGS. 3 and 4. When a given period expires, it can execute the operation described with reference to FIG. 8. This remote UI image includes buttons R and G, and the operation guides of these buttons.

Further, when the remote controller 400 is operated, a control command indicating that the display of “recording reservation list” is requested is generated. This control command is transmitted to server 500.

Suppose the remote controller is operated and the display of “recording reservation list” is requested. The control command generator 2311 generates a control command indicating that the display of “recording reservation list” is requested. This control command is transmitted to server 500. Server 500 replies an instruction command to the client device 100 in response to the control command. The instruction command is analyzed in the instruction command receiver 2313. Then, the instruction command response processor 2315 operates in accordance with analysis content of the instruction command.

In this case, server 500 transmits, for example, the remote UI data for displaying “recording reservation list” shown in FIG. 9 to the television apparatus 100, and instructs the client device 100 to display the remote UI image. This remote UI image includes buttons R, G and B, and the operation guides of these buttons.

An instruction command response processor 235 of the client device 100 outputs the image of “recording reservation list” to the display 134 based on the instruction from server 500.

Further, the instruction command response processor 235 reads data concerning buttons R, G and B from the memory 211 in response to the instruction command for displaying buttons R, G and B and operation guides corresponding to them, and displays buttons R, G and B and the operation guide corresponding to each of buttons R, G and B, as described with reference to FIG. 9.

Suppose the remote controller is operated and the display of “item for various settings” is requested. In this case, the remote UI image as described with reference to FIG. 10 is obtained.

As described above, in the embodiment, the client device 100 can request the right of use of some area (second area) on the screen of the display 134, and return the right of use in accordance with various operating situations of the client device 100. If the right of use is returned, the returned second area falls under the jurisdiction of server 500. In this case, the operation guide of the uncertain operation button or ambiguous operation button can be displayed based on the instruction command from server 500 in the second area.

In the above embodiment, a plurality of operation guides for a button is prestored in the memory 211. However, in another embodiment, when recognizing the client device 100 and its remote controller 400, server 500 may transmit a plurality of operation guide data items for a button to the client device 100, and store the plurality of operation guide data items for a button in the memory 211.

That is, server 500 can generate the remote UI data (including an instruction command and images of a button and an operation guide) based on the button information transmitted from the client device 100, and transmit it to the client device 100 in advance or as necessary. Then, the client device 100 can store the remote UI data in the memory 211 as the plurality of operation guide data items for a button.

After the plurality of operation guide data items for a button is stored in the memory 211, server 500 can transmit the instruction command including specific data for specifying the operation guide corresponding to the button in accordance with the situation of each operation. The client device 100 displays the specified button and operation guide in accordance with this instruction command.

FIG. 13 shows a typical configuration example of a server according to each embodiment. Server 500 according to the embodiment can include a transmitting and receiving unit 511, be connected to a LAN, and communicate with the client device 100. The server is not necessarily connected to the LAN. It may be connected to the Internet.

Server 500 includes a control command analysis and instruction command selection unit 512, a button information table analyzer 515, memory 520 and a data update processor 522. It also includes a remote UI data generator 530.

First, the remote UI data generator 530 can generate an image corresponding to a button described as button information and data of an operation guide of the button when communication with the client device 100 is started and the button information table (refer to FIG. 7) is transmitted from the client device 100. For example, data as stored in the memory 211 of FIG. 12 can be generated. This data is treated as remote UI data for the client device 100.

The remote UI data can also include position information for controlling and/or managing the display area of the display 134 of the client device 100. The position information is information for managing the first area 1000, the second area 1013, etc., as described with reference to FIGS. 4 and 5. This position information is prepared in a position (jurisdiction) information manager 5302. Various types of position information is selected from the position information manager 5302 in accordance with the situation of the client device 100, and transmitted to the client device 100. The situation indicates a situation where the client device 100 is shifted to the state of FIG. 4, or where it is in the state of FIG. 5. Thus, the position information output from the position (jurisdiction) information manager 5302 is switched when a UI control right handover request and a UI control right return notice arrive.

Server 500 can pre-transmit the remote UI data to the client device 100 through the control command analysis and instruction command selection unit 512. Alternatively, appropriate UI image data as well as the instruction command may be transmitted to the client device 100 as necessary, when the remote UI data is stored in the memory, and the control command is transmitted from the client device 100. The remote UI data and/or UI image data to be selected and replied to the client device 100 is determined based on the information transmitted from the client device 100 and a program installed in the server.

In the above description, the remote UI data generator 530 generates the remote UI data when the button information is transmitted from the client device 100. However, the remote UI data for various client devices may be prestored in a memory. Further, the remote UI data for new client devices or upgraded client devices may be updated by the data update processor 522.

Memory 520 stores an instruction command corresponding to a control command generated based on an operation signal of a remote controller as an instruction command table. Moreover, not only an instruction command table for one remote controller but also that for various remote controllers is stored.

An instruction command table to be adopted is determined in accordance with an analysis result by a command information table analysis unit 515 configured to analyze command information transmitted from a client device when communication with the client device is started.

Suppose a control command for requesting, for example, display of the program guide is obtained by this analysis result. In this case, server 500 transmits an instruction command to display “program guide”, that to display buttons R and G and that to display the operation guide for each button to the client device 100.

Memory 520 and the remote UI data generator 530 may be integrally formed. Needless to say, data processing blocks in server 500 may be constituted by software.

That is, server 500 according to the embodiment fundamentally includes a receiver and a transmitter. The receiver is configured to receive a button information table of a plurality of operation buttons for operating a television receiver (client device) from the client device. The transmitter is configured to reply an operation button to be displayed in the client device and an instruction command concerning an operation guide to be displayed to the client device as reply information based on a control command corresponding to an arbitrary operation button operated in the client device.

In the above description, even if the word “unit” is replaced with the word “apparatus”, “device”, “block” or “module” with respect to the term of each block, the embodiment defined by each word falls under the category of the present invention. In each structural element of claims, even if a structural element is divided and expressed, a plurality of structural elements are jointly expressed, or these are combined, the claims fall under the category of the present invention. Further, even if a claim is expressed as a method, as control logic, as a program including instructions to be executed by a computer, and as a computer-readable storage medium including the instructions, the device of the present invention is applied.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a receiver configured to communicate with an external device based on an operation of an arbitrary operation button, and to acquire, from the external device, user interface (UI) data including identification information for identifying a plurality of areas constituting a display screen and at least one image associated with the identification information, the plurality of areas including a first area and a second area different from the first area, the at least one image including a first image, and the first image being associated with first identification information indicative of the first area;
a request unit configured to make a request for specifying the second area to the external device, and to accept a right of use of the second area from a control area of the external device; and
an image generator configured to generate a screen image in which the first image is arranged in the first area based on the UI data and a second image generated based on a unique operation is arranged in the second area, after the right of use of the second area is accepted.

2. The electronic device of claim 1, further comprising a UI control right return notification unit configured to return the right of use of the second area to the external device.

3. The electronic device of claim 1, wherein the image generator arranges an image based on new UI data from the external device in the second area if the right of use of the second area is returned to the external device.

4. The electronic device of claim 1, wherein an image displayed in the second area is an image indicating a button and a guide corresponding to a specific operation key of a remote controller.

5. The electronic device of claim 1, wherein
the image generator includes an operation button and/or an operation guide which are likely to be operated by a user in the second image with respect to the arbitrary operation button, the operation button and/or the operation guide which are likely to be operated by the user being information for setting the electronic device.

6. The electronic device of claim 1, wherein
the image generator includes an operation button and/or an operation guide which are likely to be operated by a user in the second image if a notice is given from a server different from the external device, the operation button and/or the operation guide which are likely to be operated by the user being information concerning another electronic device connected to the server.

7. A method of controlling an electronic device comprising a user interface (UI) data processor configured to communicate with an external device based on an operation of an arbitrary operation button, to acquire, from the external device, UI data including identification information for identifying a plurality of areas constituting a display screen and at least one image associated with the identification information, and to process the UI data, the plurality of areas including a first area and a second area different from the first area, the at least one image including a first image, and the first image being associated with first identification information indicative of the first area, the method comprising:
making a request for specifying the second area to the external device, and accepting a right of use of the second area from a control area of the external device; and
generating a screen image in which the first image is arranged in the first area based on the UI data and a second image generated based on a unique operation is arranged in the second area, after the right of use of the second area is accepted.

8. The method of claim 7, further comprising:
making a UI control right handover request to the external device to secure the second area, and accepting the right of use of the second area from the control area of the external device.

9. The method of claim 7, further comprising:
returning the right of use of the second area to the external device.

10. The method of claim 7, wherein
the second area is used based on new UI data from the external device if the right of use of the second area is returned to the external device.

11. The method of claim 7, wherein
an image displayed in the second area is an image indicating a button and a guide corresponding to a specific operation key of a remote controller.

12. The method of claim 7, wherein
an operation button and/or an operation guide which are likely to be operated by a user are included in the second image with respect to the arbitrary operation button, the operation button and/or the operation guide which are likely to be operated by the user being information for setting the electronic device.

13. The method of claim 7, wherein
an operation button and/or an operation guide which are likely to be operated by a user are included in the second image if a notice is given from a server different from the external device, the operation button and/or the operation guide which are likely to be operated by the user being information concerning another electronic device connected to the server.

14. A system for controlling an electronic device, comprising a client device and an external device,
wherein the client device comprises:
a receiver configured to communicate with the external device based on an operation of an arbitrary operation button, and to acquire, from the external device, user interface (UI) data including identification information for identifying a plurality of areas constituting a display screen, and at least one image associated with the identification information, the plurality of areas including a first area and a second area different from the first area, the at least one image including a first image, and the first image being associated with first identification information indicative of the first area;
a request unit configured to make a request for specifying the second area to the external device, and to accept a right of use of the second area from a control area of the external device; and
an image generator configured to generate a screen image in which the first image is arranged in the first area based on the UI data and a second image generated based on a unique operation is arranged in the second area, after the right of use of the second area is accepted, and
wherein the external device comprises:
a receiver configured to receive a control command corresponding to the operation button from the client device;
an analyzer configured to analyze the control command;
a UI data generator configured to generate the UI data based on an analysis result of the analyzer; and
a selection unit and a transmitter which are configured to select the generated UI data and to reply the generated UI data to the client device.
